(19) United States
(12) Patent Application Publication
(10) Pub. No.: US 2003/0210703 A1
(43) Pub. Date: Nov. 13, 2003

(54) Method of managing frame and switch and network structure thereof

(75) Inventor: Chih-Fang Lee, Jen Te Hsiang (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Accton Technology Corporation

(21) Appl. No.: 10/142,797

(22) Filed: May 13, 2002

(51) Int. Cl. H04L 12/28

(52) U.S. Cl. 370/412

(57) ABSTRACT

A method of managing frame and switch and network structure thereof is disclosed. The method of managing frame provided by the present invention comprises: assigning a FIFO queue of a network connect device a higher processing priority level and other FIFO queues a lower processing priority level; and allocating a control frame to the FIFO queue having the higher processing priority level, wherein the control frame is a control signal which is required for the operation of network connection device and is outputted by a control device that is built in or built externally to the network connection device. By utilizing the present invention, the control frames among network connection devices can be processed and transmitted in advance of other frames, so as to decrease the delay of forwarding the control frames or the time between receiving and transmitting the control frames, thereby promoting the network service quality.

### FIELD OF THE APPLICATION

The present invention relates to a method of managing frame, and the switch and network structure thereof, and more particularly, to a method of managing frame applied on a network connection device (such as a switch) by arranging the control frame required for the operation of the network connection device to a proper queue, thereby promoting the operation efficiency of the network connection device.

### BACKGROUND OF THE APPLICATION

With the popularity of personal computer and the rising and fast development of Internet, there are more and more individuals and groups having multiple personal computers or electronic information products. For sharing the resources between those personal computers or electronic information products, network communication has become a convenient and popular means. However, among many mutually linked networks, there are various protocols and standards regardless of hardware or network structure/type, etc. Hence, proper network connection devices are needed while multiple networks are combined together to form a mutually linked Internet.

Currently, the commonly used network connection devices are: hubs, bridges, switches and routers, etc. As the hubs and the bridges lack of function of filtering frames, and the cost of routers is relatively higher than that of others, the switches thus have been gradually becoming a network connection device that is popularly adopted in considerable quantities.

In the network connection device such as the switch, etc., each of the ports has a fixed corresponding memory zone, and generally, the memory zone is a FIFO (First In First Out) queue or a FIFO buffer. While the switch executes the operation of transmitting, receiving or forwarding a frame, the frame is temporarily stored in the FIFO queue

Referring to FIG. 1, FIG. 1 is a schematic diagram showing the frame processed inside a conventional switch. After a frame 30 enters a switch 10 via a port 20, the switch 10 performs a frame filtering treatment 40 to check if the frame 30 can be forwarded via other ports to the destination to which the frame 30 is assigned. After it is confirmed from the frame filtering treatment 40 that the frame 30 can be forwarded, the frame 30 then is processed in a frame allocation treatment 50, wherein, based on the factors of: the destination to which the frame 30 is assigned; the data type of the frame 30 (such as a control frame, a audio signal frame or a video signal frame, etc.); and the internal configuration setting of the switch 10, the frame 30 is allocated and temporarily stored in a FIFO queue 80 corresponded by the port 70 that is responsible for forwarding the frame 30. Thereafter, the frame 30 is sequentially and timely transmitted out from the port 70 via a frame-transmitting means 60.

In the network communication, besides the frames are continuously transmitted, control frames are also transmitted among each of the network devices and network connection devices, so as to confirm the transmitting status of both parities (such as point to point network communication) or multiple parties (such as broadcast network communication), and then to continuously make adjustments, so that the data frames can be transmitted or received even more smoothly, accurately and quickly. Hence, whether the control frames can be transmitted and received among each of the network devices and network connection devices promptly and correctly, has a great influence on the network operation efficiency and the communication service quality.

When the network is not busy, the FIFO queue inside the network connection device (such as the switch or the router, etc.) is not fully loaded due to less information flow. Therefore, the frame can be allocated lightly to a FIFO queue corresponded by a proper port and be waited for being transmitted out, according to the information (such as frame data type, processing priority level and destination, etc.) contained in the frame received. Meanwhile, the control frames required for the network operation can also be effectively allocated to a FIFO queue to be waited for being transmitted, received or processed, so that the network can be smoothly operated.

However, as the network is getting busier and the traffic thereof is heavier, the frame amount processed by the switch is also greatly increased, so that the FIFO queue inside the switch will be fully loaded shortly. Even though the control frames required by the network operation has a priority level higher than what other data frames have in transmission, reception or treatment, yet the FIFO queue has been already or almost fully-loaded, the control frames cannot be transmitted, received or processed until the frames scheduled before them are completely processed or transmitted/received. As a result of that, the transmission and reception of the control frames can not executed at normal speed, so that the network connection device is not able to receive the control frames timely and correctly, thus effecting and lowering the network service quality.

### SUMMARY OF THE APPLICATION

In view of the aforementioned background of the invention, since the control frames required for the operation of a network connection device is often mixed with other data frames and temporarily stored in a FIFO buffer of the network connection device while in transmission and reception, the transmission, reception or treatment thereof is thus delayed, and the network connection device cannot obtain timely and correct control frames, thus effecting the network service quality.

Therefore, it is an object of the present invention to provide a method of managing frame, and the switch and network structure thereof, and particularly, the method of managing frame can be applied on a network connection device (such as a switch), by arranging the control frames required for the operation of the network connection device to a FIFO queue having a higher processing priority level in the network connection device, thereby enabling the control frames to be processed prior to the data frames of other data types. Consequently, the network connection device can transmit the control frames timely and correctly, so as to resolve the problems that the conventional control frames fail to be transmitted, received or processed timely.

In accordance with the aforementioned object of the present invention, the present invention provides a method of managing frame, and the switch and network structure thereof. The method of managing frame comprises: assigning one of a plurality of FIFO queues a higher processing priority level, and the rest of the FIFO queues a lower processing priority level; and allocating a control frame to the FIFO queue having the higher processing priority level, wherein the control frame is a control signal required for the operation of the network connection device, and is outputted by a control device built in the network connection device or externally connected thereto.

Moreover, the present invention also provides a switch using the method of managing frame, the switch comprising: a plurality of FIFO buffers each of which has a plurality of FIFO queues, wherein one of the FIFO queues has a higher processing priority level, and the rest of the FIFO queues have a lower processing priority level; and an allocation means for allocating a control frame to the FIFO queue having the higher processing priority level, wherein the control frame is required for the operation of the network connection device, and can be outputted by a control device built in the network connection device or externally connected thereto, and then inputted to the switch via a network connection.

On the other hand, the present invention also provides a network structure using the method of managing frame, and the network structure comprises: a first network connection device; a second network connection device comprising a first port and a second port, wherein the first port is connected to the first network connection device via a network connection, and the first port has a first buffer group, one first FIFO queue of the first buffer group having a processing priority higher than what the rest of the first FIFO queues of the first buffer group have, and the second port has a second buffer group, one second FIFO queue of the second buffer group also having a processing priority level higher than what the rest of the second FIFO queues of the second buffer group have; and a control device outputting a control frame for controlling the first network connection device, wherein the control frame is temporarily stored in the first FIFO queue of the first buffer group, and the control frame is a control signal required for the operation of the first network connection device, and the control frame can be outputted by a control device built in the network connection device or externally connected thereto. By means of the method of managing frame, and the switch and network structure thereof, according to the present invention, the control frames among network connection devices can be processed and transmitted in advance of other data frames, thereby lowering the delay of forwarding the control frames or the time between receiving and transmitting the control frames, thus promoting the network service quality.

### BRIEF DESCRIPTION OF THE DRAWINGS

The foregoing aspects and many of the attendant advantages of this application will become more readily appreciated as the same becomes better understood by reference to the following detailed description, when taken in conjunction with the accompanying drawings, wherein:

FIG. 1 is a schematic diagram showing the frame processed inside a conventional switch;

FIG. 2 is a schematic diagram showing a switch of a preferred embodiment of the present invention and the frame processed therein; and

FIG. 3 is a schematic diagram showing a network structure of a preferred embodiment of the present invention.

### DETAILED DESCRIPTION OF THE PREFERRED EMBODIMENT

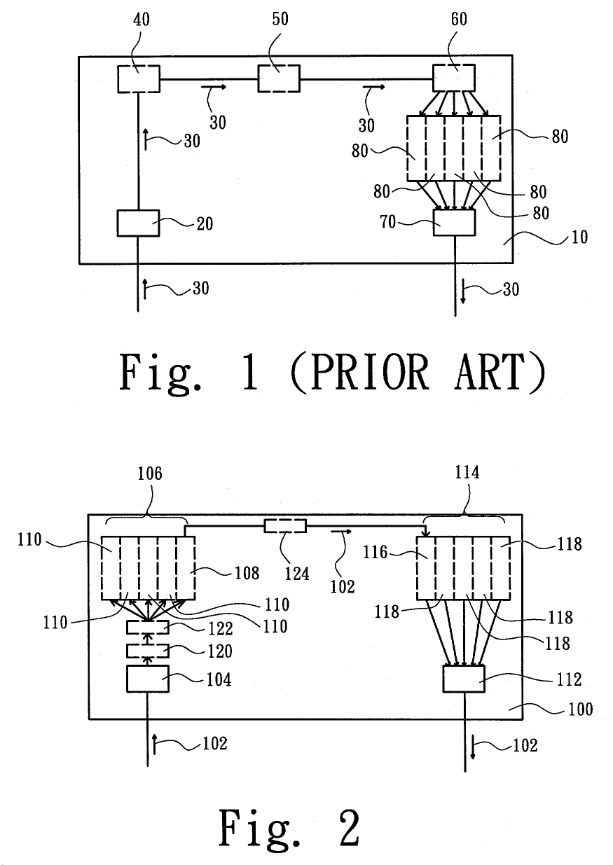

Referring to FIG. 2, FIG. 2 is a schematic diagram showing a switch of a preferred embodiment of the present invention and the frame processed therein. Such as shown in FIG. 2, a switch 100 has a plurality of ports used for connecting a multitude of network devices and network connecting devices, and each of the ports has a corresponding FIFO buffer group used for storing the input or output frames. Besides, in the FIFO buffer group corresponding to each of the ports, a FIFO queue is assigned a higher processing priority level, and the rest of the FIFO queues in the FIFO buffer group are assigned a lower processing priority level, i.e. the frames temporarily stored in the FIFO queue having the higher processing priority level will be processed in advance of the FIFO queues having the lower processing priority level. Further, the allocation means 124 is set up in accordance the configuration of the switch 100, so as to allocate each of the frames inputted into the switch 100 to a proper FIFO queue.

Therefore, according to the method of managing frame of the present invention, when a frame 102 is inputted from a port 104, the switch 100 first executes a frame filtering treatment 120 to inspect if the frame 102 can be forwarded via the other ports of the switch 100 to a destination to which the frame 102 is assigned. After the frame filtering treatment 120 is performed, a discrimination treatment 122 is executed to determine if the frame 102 is a control frame. If the frame 102 is a control frame, the frame 102 will be temporarily stored in a FIFO queue 108 having the higher processing priority level in a FIFO buffer 106 corresponding to the port 104. If the frame 102 is not a control frame, the frame 102 will be temporarily stored in one of the other FIFO queues 110.

Since the FIFO queue 108 in the FIFO buffer group 106 has the higher processing priority level, and the other FIFO queues 110 merely have the lower processing priority level, the frame 102 stored in the FIFI queue 108 can be processed shortly, so that the switch 100 may properly allocate the frame 102 to a FIFO queue 116 having the higher processing priority level in a FIFO buffer group 114, based on the information (such as the frame data type, the process priority level and the destination, etc.) contained in the frame 102, wherein the FIFO buffer group 114 corresponds to a port 112. Thereafter, according to the FIFO rules, the frame 102 can be quickly transmitted out via the port 112. On the other hand, the other FIFO queues 118 having the lower processing priority level in the FIFO buffer group 114 are used for temporarily storing the other frames that are not control frames. Hence, while being transmitted, received or forwarded between a network device and a network connection device (such as a switch, etc.), the control frames can be distinguished from the frames of other types, and temporarily stored in the FIFO queue having the higher processing priority level. Consequently, the control frames can be transmitted and received in advance of the other frames, so that the communication and control between a network device and a network connection device can be more accurate, thereby promoting the network service quality.

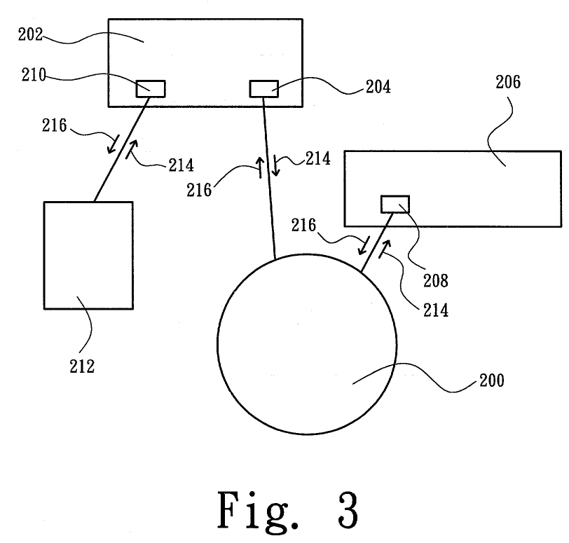

Moreover, the present invention also provides a network structure applying the method of managing frame. Referring to FIG. 3, FIG. 3 is a schematic diagram showing a network structure of a preferred embodiment of the present invention. In the network structure as shown in FIG. 3, a network 200 links a network connection device 202 and a network connection device 206 via a port 204 of the network connection device 202 and a port 208 of the network connection device 206, wherein a port 210 of the network connection device 202 is connected to a control device 212 used for controlling the network connection device 206. The control frames required for the control operation are transmitted via the network connection device 202 and the network 200.

When control frames 214 are transmitted to the network connection device 206 from the control device 212, the control frames 214 are temporarily stored in a FIFO queue having a higher processing priority level in a FIFO buffer group of the port 210, and then are transmitted to the network connection device 206 sequentially and timely via the port 204 and the network 200. After the control frames 214 pass through a frame filtering treatment and a discrimination treatment in the network connection device 206, a FIFO queue having the higher processing priority level in the port 208 is planned for use in temporarily storing the control frames 214, and thereafter the network connection device 206 processes the control frames 214 in sequence.

Similarly, when control frames 216 are transmitted to the control device 212 from the network connection device 206, the control frames 216 are first temporarily stored in the FIFO queue having the higher processing priority level in the port 208, and then sequentially transmitted to the network connection device 202 via the port 208 and the network 200. After the control frames 216 pass through a frame filtering treatment and a discrimination treatment in the network connection device 202, a FIFO queue having the higher processing priority level in the port 204 is planned for use in temporarily storing the control frames 216, and thereafter the network connection device 202 transmits the control frames 216 in sequence to the control device 212.

Hence, it is an advantage of the present invention to provide a method of managing frame, and the switch and network structure thereof. According the method of managing frame of the present invention, after being transmitted to or before being received by a network connection device, the control frames required by the network connection device are temporarily stored in a queue having a higher processing priority level so as to be processed in advance of the frames of other data types, thereby lowering the delay of forwarding the control frames or the time between receiving and transmitting the control frames, thus promoting the network service quality.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A method of managing frame applied on a network connection device having a plurality of queues, said method of managing frame comprising:
assigning a queue of said plurality of queues a first processing priority level, and the rest of said plurality of queues a second processing priority level, wherein said queue having said first processing priority level is processed in advance of the rest of said plurality of queues having said second processing priority level, and said first processing priority level is a higher processing priority level, and said second processing priority level is a lower processing priority level, and
allocating a control frame to said queue having said first processing priority level, wherein said control frame is used for providing a control signal required for the operation of said network connection device.

2. The method of managing frame according to claim 1, wherein said control signal is outputted by a control device built in said network connection device.

3. The method of managing frame according to claim 1, wherein said control signal is outputted by a control device, and said control device is connected externally to said network connection device, and said control frame is inputted into said network connection device via a network connection.

4. The method of managing frame according to claim 1, wherein said plurality of queues are a plurality of FIFO (First In First Out) queues.

5. A switch using a method of setting frame, comprising
a plurality of ports;
a plurality of buffer groups, each of said plurality of buffer groups comprising a plurality of queues, each of said plurality of buffer groups corresponding to each of said plurality of ports respectively, wherein a queue of said plurality of queues is predetermined to have a first processing priority level, and the rest of said plurality of queues are predetermined to have a second processing priority level, and said queue having said first processing priority level is processed in advance of the rest of said plurality of queues having said second processing priority level; and
an allocation means used for allocating a control frame to said queue having said first processing priority level, wherein said control frame is used for providing a control signal required for the operation of said switch.

6. The switch using said method of managing frame according to claim 5, wherein said control frame is outputted by a control device built in said switch.

7. The switch using said method of managing frame according to claim 5, wherein said control signal is outputted by a control device, and said control device is connected externally to said network connection device, and said control frame is inputted into said switch via a network connection.

8. The switch using said method of managing frame according to claim 5, wherein said plurality of queues are a plurality FIFO queues.

9. A network structure using a method of setting frame, comprising
a first network connection device;
a second network connection device comprising a first port and a second port, wherein said first port is connected to said network connection device via a network connection, and said first port has a first buffer group of which a first queue is assigned a first processing priority level higher than that assigned to other first queues in said first buffer group, and said second port has a second buffer group of which a second queue is assigned a second processing priority level higher than that assigned to other second queues in said second buffer group; and
a control device outputting a control frame used for controlling said first network connection device, wherein said control frame is temporarily stored in said first queue, and then is transmitted to said first network connection device via said first port.

10. The network structure using said method of managing frame according to claim 9, wherein said second connection device is a switch.

11. The network structure using said method of managing frame according to claim 9, wherein said control device is built in said second network connection device.

12. The network structure using said method of managing frame according to claim 9, wherein said control device is connected externally to said second network connection device, and said control device is connected to said second port of said second network connection device via a network connection, and said control frame is first temporarily stored in said second queue via said second port and thereafter temporarily stored in said first queue.

13. The network structure using said method of managing frame according to claim 9, wherein said first buffer group comprises a plurality first FIFO queues.

14. The network structure using said method of managing frame according to claim 9, wherein said second buffer group comprises a plurality second FIFO queues.
